(19) United States
(12) Patent Application Publication
(10) Pub. No.: US 2009/0132491 A1
(43) Pub. Date: May 21, 2009

(54) Data Processing System And Method

(76) Inventors: Aditya DESARAJU, Oxford (GB); Deepak Bhat, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/107,088

(22) Filed: Apr. 22, 2008

(30) Foreign Application Priority Data
Nov. 19, 2007 (IN) 2684/CHE/2007

(51) Int. Cl. G06F 7/10

(52) U.S. Cl. 707/3; 707/E17.014

(57) ABSTRACT

A method of selecting at least one service, the method comprising receiving a service request; and selecting one or more services that meet requirements indicated in the service request from a plurality of services.

### RELATED APPLICATIONS

Benefit is claimed under 35 U.S.C. 119(a)-(d) to Foreign application Ser. 2684/CHE/2007 entitled “DATA PROCESSING SYSTEM AND METHOD” by Hewlett-Packard Development Company, L.P., filed on 19 Nov., 2007, which is herein incorporated in its entirety by reference for all purposes.

### BACKGROUND TO THE INVENTION

Many businesses provide remote services, which are services that operate in a location that may be remote from users of the services. An example of a remote service could be a loan application, where a user sends details from a loan application form to a remote service, and the remote service processes the details and takes action (in this case, for example, refusing the loan or causing the loan to proceed). Remote services are accessible over a network such as, for example, the internet. A remote service that is accessible over the internet may be known as a “web service.” The services operate, for example, by receiving one or more messages from a user over the network, taking actions if necessary, and sending a response to the user over a network. A “user” may be a person or another service.

A “service oriented architecture” (SOA) comprises such services. A SOA represents software assets as services. Services behave as black boxes in that a user of a service only uses the interface of the service and does not necessarily have knowledge of the internal workings of the service. Services can be used as building blocks for other services and applications where the emphasis is on application assembly rather than implementation details.

UDDI (Universal Description, Discovery and Integration) is a database or registry that can be used for one or more business to store information relating to one or more remote services. The information may include, for example, information describing the interfaces of the services (the format and/or content of messages sent to and/or received from the services). An example of a UDDI database includes Systinet. The interfaces of the services listed in the UDDI registry are described using WSDL (Web Service Description Language). A service description is a WSDL document that describes the interface used by a service.

It is an object of embodiments of the invention to at least mitigate one or more of the problems of the prior art.

### BRIEF DESCRIPTION OF THE DRAWINGS

Embodiments of the invention will now be described by way of example only, with reference to the accompanying drawings, in which:

FIG. 1 shows an example of a system for selecting one or more services according to embodiments of the invention;

FIG. 2 shows an example of a method of selecting one or more services according to embodiments of the invention; and

FIG. 3 shows an example of a data processing system suitable for use with embodiments of the invention.

### DETAILED DESCRIPTION OF EMBODIMENTS OF THE INVENTION

Remote services may be registered in a UDDI registry. A registered remote service has a corresponding WSDL service description document included within the UDDI registry. Existing UDDI registries have limited discovery capabilities. Thus, a user must generally know the exact service required. Furthermore, the user must comply with the static interface of the required service as indicated in the corresponding web service description stored in the UDDI registry.

Embodiments of the invention introduce information associated with each remote service registered in a UDDI registry. This information can be used to select one or more appropriate services from the registered services. The selected service or services can then be used by a user.

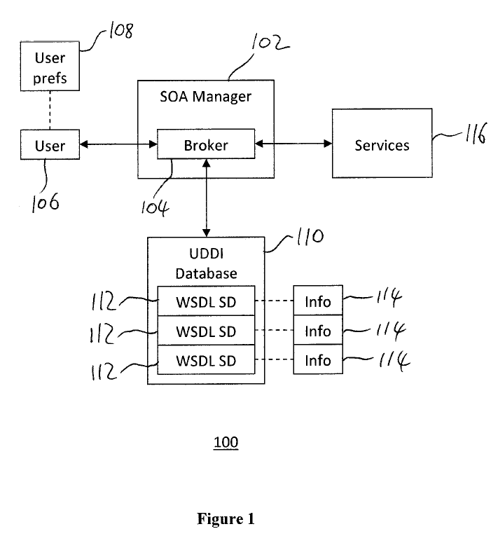

FIG. 1 shows an example of a system 100 that can be used for selecting a service according to embodiments of the invention. The system 100 includes a SOA (Service Oriented Architecture) Manager (SOAM) 102. The SOAM 102 includes a broker 104. The broker 104 may receive queries from a user 106. The user 106 may be associated with user preferences and constraints 108.

The broker 104 may access a UDDI registry 110 (for example, Systinet). The UDDI registry 110 includes a plurality of WSDL service descriptions (WSDL SD) 112. Three service descriptions 112 are shown, although the UDDI registry 110 may include any number of service descriptions. Each service description 112 is associated with respective information 114. In embodiments of the invention, the information 114 may be stored within the UDDI registry 110. For example, the information 114 associated with a service can be stored within the service description 112 of that service. However, in alternative embodiments of the invention, the information 114 may be located elsewhere in the UDDI registry 110 or outside of the UDDI registry 110.

The broker 104 may also access remote services 116.

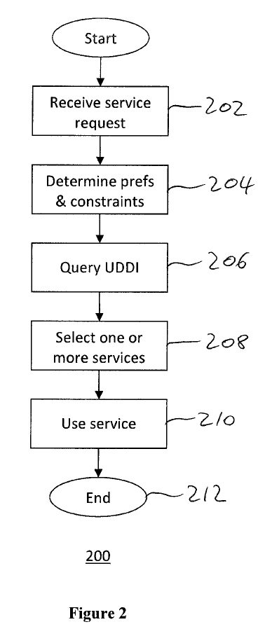

FIG. 2 shows a method 200 of selecting at least one service according to embodiments of the invention. The method 200 starts at step 202 where the broker 104 receives a service request from the user 106. The service request is sent by the user 106 in response to a desire to access a remote service 116. However, the user does not know the specific service that may be required or suitable, and may not know specific interfaces of the services 116. The service request includes details of the user's requirements for a service. For example, requirements indicated in a service request from the user 106 may comprise the keywords “buy property”, indicating that the user wishes to buy property. The user 106 may not know the specific remote service or services that are suitable for the user 106.

Following from step 202, in step 204 the broker 104 determines preferences and constraints 108, if any, associated with the user 106. That is, if there are any user preferences and constraints 108, the broker 104 accesses them. This may be done in one or more of a number of ways. For example, the user may use Select Access, a software product from Hewlett Packard, to access the broker 104. Select Access allows the user 106 to access the broker 104 using login details that may include a password. The user 106 goes through an “authentication” or “validation” process. The result of this process determines whether the broker allows the service request to continue. In this way, only selected users may be allowed access to the broker 104 and services 116. With a login that is specific to the user 106, user preferences and constraints 108 specific to the user 106 may be stored (for example, on the SOA Manager 102) and accessed by the broker 104 when required. Thus, the user 106 may not need to identify himself to the broker 104 as this has already been done using the specific login. The user preferences and constraints 108 may include details, specified by (for example) the user 106, of preferences and constraints that must be met by any services 116 selected in the method 200.

Once the user preferences and constraints 108 have been accessed in step 204, the broker 104 queries the UDDI database 110 in step 206. The broker queries the UDDI registry 110 by finding those services whose associated information 114 matches requirements indicated in the service request from the user 106 to the broker 104. In embodiments of the invention, the information 114 associated with a service contains tuples comprising a text description of the service, and/or text descriptions of capabilities of the service, and/or text that is associated with the service and/or capabilities but is not necessarily a description. Finding services may comprise, for example, finding services whose information 114 includes all of the keywords indicated in the request for service from the user 106. The UDDI registry 110 may return, for example, a list of matching services to the broker 104. For example, where the service request from the user includes the keywords “buy property”, the list of matching services indicates those services whose associated information 114 includes these keywords.

Next, in step 208, the broker 104 selects one or more services from the matching services. This may involve, for example, selecting those services in the list that also meet the user preferences and constraints 108 specified by the user, if any.

In alternative embodiments, steps 206 and 208 may be implemented in different ways. For example, the UDDI registry 110 may provide the broker 104 with a list of all services, and the broker 104 may search this list to find those services that match the requirements specified in the service request and also the user preferences and constraints 108. Alternatively, for example, the UDDI registry 110 may provide a list of those services that both meet the requirements of the service request and also the user preferences and constraints 108, and all of these services are the services “selected” by the broker 104.

Where multiple services are selected by the broker 104 in step 208, a number of approaches may follow depending on implementation and/or user requirements, for example. For instance, the user may be provided with a list of selected services, and the user may be able to choose one or more of these. Alternatively, the broker may choose one of the services using any number of criteria. A simple way of choosing a service may comprise choosing one of the selected services based on the order in the UDDI registry 110—for example, a service listed higher in the UDDI registry 110 is chosen in preference to other, lower listed services. Alternatively, all of the selected services may be chosen. The chosen service or services are accessed by the broker as indicated below.

In step 210 of the method 200, a remote service is used by the broker 104. The remote service that is used is the selected service selected in step 208 or, where there are multiple selected services, the chosen service or service as indicated above. The broker 104 communicates with the service (or services) by forming a query to be sent to the service 116. The query conforms to the definition of the service's interface as indicated in the corresponding WSDL service description 116, and includes at least some of the requirements indicated in the service request from the user 106 to the broker 104. The format and content of the query to the service therefore depends on the interface described in the appropriate WSDL service description 112. Any response from the service 116 to the broker 104 can be forwarded to the user 106. Subsequent communications between the user 106 and service 116 may be made through the broker 104 or without the broker 104. Once the service has been called in step 210, the method 200 ends at step 212.

In this way, the user may access a service even if the user does not know the specific service that may be used, and/or the interface that is required for use of the service.

In alternative embodiments of the invention, the service or services to be used are indicated to the user 106 by the broker 104. Any communications between the user 106 and service 116 may be made through the broker 104 or without the broker 104. The query from the user 106 to the service 116 may be formed automatically without any or significant contribution from the user, for example by a data processing system (not shown) being used by the user 106.

Below is an example of information 114 that is associated with a service that provides real estate/land buying and selling services:

```
Description, D => “Service for real estate transactions”
Operations, O => {
    {buyLand, getLandPrices, sellLand}
    OperationRegulation, OR => {Regulation {buyLand}, Regulation
        {getLandPrices}, Regulation {sellLand}}
    OperationalPurpose, OP => {Purpose {Oᵢ}}
    OperationalDescription, OD => {
        buyLand {“Helps to buy land”},
        getLandPrices {“Retrieves land prices”},
        sellLand {“Helps to sell land”} }
    OperationalCategory, OC => {Category {Oᵢ}, Input {Oᵢ}, Output
        {Oᵢ}, Quality {Oᵢ}}
}
Purpose, P => {buyLand {“Request to buy land”}, getLandPrices
    {“Request to get land prices”}, sellLand {“Operation to sell
    land”}}
Category, C => {buyLand {“Real estate”, {“Land sellers”, “Land
    purchasers”}, {“Govt approved”}}, getLandPrices {“Real estate”,
    {“Get quotes”, “Get prices”}, {“Cheapest”}}, sellLand {“Real
    estate”, {“Sell land”, “Trade”}, “Best prices”}}
```

The above information indicates that there are three operations offered by the service—these are all or part of the capabilities of the service. There are also description, purpose and category associated with each of the operations, as well as a description for the service itself. The description for the service itself is “Service for real estate transactions”. The descriptions for the operations are indicated in the following table:

| Operation | Description | Purpose | Category |
|---|---|---|---|
| buyLand | Helps to buy land | Request to buy land | Real estate |
| getLandPrices | Retrieves land prices | Request to get | Real estate |
| | | land prices | |
| sellLand | Helps to sell land | Operation to sell | Real estate |
| | | land | |

Another example of information 114 is provided below. This example is of a service that provides government property buying and selling services:

```
Description, D => {“Services to process property buying”}
Operations, O => {
    {registerProperty, getConnections}
    OperationalRegulation, OR => {Regulation {registerProperty},
        Regulation {getConnections}}
    OperationalPurpose, OP => {Purpose {Oᵢ}}
    OperationalDescription, OD => {
        registerProperty {“Registers property” },
        getConnections {“Gets basic connections such as
            electricity”} }
    OperationalCategory, OC => {Category{Oᵢ}}, Input {Oᵢ}, Output
        {Oᵢ}, Quality {Oᵢ}}
}
Purpose, P => {registerProperty {“Register property”}, getConnections
    {“Get connections”}}
Category, C => {registerProperty {“Govt undertaking”, {“Register
    land”, “Real estate services”}}}
```

This information can be represented as a similar table:

| Operation | Description | Purpose | Category |
|---|---|---|---|
| registerProperty | Registers property | Register property | Govt |
| | | | undertaking |
| getConnections | Gets basic | Get connections | — |
| | connections such as | | |
| | electricity | | |

The description of this service is also specified as “Services to process property buying”.

The above information may be implemented in the form given above, or the form given above may be representative of the detains in the information and the information may be implemented/described in other forms, such as WSDL for example.

If, for example, the service request from the user 106 to the broker 104 contains the keywords “buy property”, the broker will select the second service given above as the selected service to be used. This is because the information for the first service does not include the keyword “property”, even though the information contains the keyword “buy” (for example, in the buyLand operation description and purpose). However, the second service contains both keywords in the description of the service. The broker regards this service as “matching” the service request. However, the service is not selected if the service does not meet user preferences and constraints 108, if any.

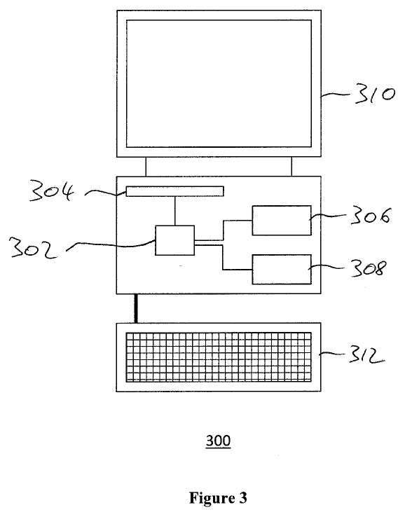

FIG. 3 shows an example of a data processing system 300. The data processing system is suitable for use in a number of ways. For example, the data processing system may be used by the user 106 to form a service request and send the service request to the broker 104. The data processing system 300 may additionally or alternatively be used to implement one or more of the SOA manager 102, broker 104, UDDI registry 110 and/or services 116. Each of these may instead be implemented as a plurality of data processing systems 300.

The data processing system 300 includes a data processor 302 and main memory 304. The data processing system may also include a permanent storage device 306 (such as a hard disk), and/or a communications device 308 for communicating, over wired and/or wireless communication links, with other data processing systems, databases and the like. The data processing system 300 may also include a display device 310 and/or a human interface device 312 (such as, for example, a mouse and/or keyboard).

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of selecting at least one service, the method comprising:
receiving a service request; and
selecting at least one service that meet requirements indicated in the service request from a plurality of services.

2. A method as claimed in claim 1, wherein each service in the plurality of services is associated with respective service information, and selecting at least one service comprises finding one or more services with respective service information that meets the requirements indicated in the service request.

3. A method as claimed in claim 2, wherein the service information includes a description of at least one of the associated service and capabilities of the associated service.

4. A method as claimed in claim 3, wherein selecting the at least one service comprises matching keywords indicated in the requirements with the description of the at least one service.

5. A method as claimed in claim 2, wherein the service information is stored within a UDDI registry.

6. A method as claimed in claim 5, wherein the service information is stored within the WSDL service description of the associated service.

7. A method as claimed in claim 1, wherein selecting the at least one service comprises finding at least one service with associated information containing keywords that match keywords indicated by the requirements.

8. A method as claimed in claim 1, wherein selecting the at least one service includes selecting the at least one service that meets predefined criteria associated with a user sending the service request.

9. A system for selecting at least one service, the system arranged to:
receive a service request; and
select at least one service that meet requirements indicated in the service request from a plurality of services.

10. A system as claimed in claim 9, wherein each service in the plurality of services is associated with respective service information, and the system is arranged to select at least one service by finding one or more services with respective service information that meets the requirements indicated in the service request.

11. A system as claimed in claim 10, wherein the service information includes a description of at least one of the associated service and capabilities of the associated service.

12. A system as claimed in claim 11, arranged to select the at least one service by matching keywords indicated in the requirements with the description of the at least one service.

13. A system as claimed in claim 10, wherein the service information is stored within a UDDI registry.

14. A system as claimed in claim 13, wherein the service information is stored within the WSDL service description of the associated service.

15. A system as claimed in claim 9, arranged to select the at least one service by finding at least one service with associated information containing keywords that match keywords indicated by the requirements.

16. A system as claimed in claim 9, arranged to select the at least one service by selecting the at least one service that meets predefined criteria associated with a user sending the service request.

17. A computer program comprising instructions for implementing one of a method as claimed in claim 1 and a system as claimed in claim 9.

18. A registry comprising a plurality of service descriptions, each service description associated with information on a respective service, the information comprising a description of at least one of the respective service and capabilities of the respective service.

19. A registry as claimed in claim 18, wherein the registry is a UDDI registry.

20. A registry as claimed in claim 18, wherein the information on a respective service is included within the service description associated with that service.

21. A registry as claimed in claim 20, wherein the service descriptions comprise WSDL documents.
